(19) United States
(12) Patent Application Publication
(10) Pub. No.: US 2014/0300610 A1
(43) Pub. Date: Oct. 9, 2014

(54) SYSTEM AND METHOD FOR USING TIME RE-MAPPING FOR COMPUTER-GENERATED ANIMATION

(71) Applicant: John Mayhew, San Francisco, CA (US)

(72) Inventor: John Mayhew, San Francisco, CA (US)

(73) Assignee: Adobe Systems Incorporated, San Jose, CA (US)

(21) Appl. No.: 11/941,829

(22) Filed: Nov. 16, 2007

(51) Int. Cl. G06T 13/00

(52) U.S. Cl. 345/473

(57) ABSTRACT

Time re-mapping is used for computer-generated animation. A time re-mapper re-maps at least a portion of an animation's reference timeline to produce a different timeline. In this way the, the re-mapping may enable a re-mapped timeline to be generated that is non-linear. The re-mapped timeline may then be employed by animation generation logic that generates some effect in the animation as a function of time. For instance, the re-mapped time may be used (e.g., in place of the animation's reference timeline) by tweening logic for generating tween frames in the animation. Thus, the re-mapping may be employed to effectively produce such animation effects as easing for the generated tween frames.

### CROSS-REFERENCE TO RELATED APPLICATIONS

Not applicable.

### TECHNICAL FIELD

The following description relates generally to computer generated animation, and more specifically to systems and methods for using time re-mapping for computer-generated animation.

### BACKGROUND

Various animation authoring tools are available today with which users may interact to create, modify and/or otherwise author animations. Examples of such animation authoring tools that enable authoring of animation include such computer-executable software applications as Adobe Systems Incorporated's FLASH® and AFTER EFFECTS® authoring tools. In general, animation refers to a graphical object that has one or more properties that change over time. For instance, in a given animation a graphical object may have its position on an output display change over time (e.g., such that the object moves across the display), the graphical object may have its size change over time (e.g., such that the object grows to a larger size or shrinks to a smaller size), the graphical object may have its shape change over time (e.g., such that the object “morphs” into a different shape), the graphical object may have its color (or “tint”) change over time, the graphical object may have its level of opacity or transparency change over time, and/or various other properties of the graphical object may change over time during the given animation. Thus, one or more of such properties of an object as the object's position (x, y), size (or “scale”), skew, rotation (or “orientation”), shape, color (or “tint”), opacity/transparency, etc. may change over time to result in an animation. Accordingly, by defining the graphical object and the various changes to it that occur over time, an author can create a graphical animation, such as a cartoon or other animation. For instance, the animation may be defined in computer-readable software code that is readable by a computer processor to present the animation to an output display. Various techniques for authoring and playing such graphical animations are well known in the art.

“Tweening” is a well-known concept in the art of animation. The word “tween” is derived from “between.” The term originates from traditional animation techniques in which animators would often draw certain keyframes for the animation, and others, perhaps those with less talent or seniority, would do the grunt work of filling in the gaps between the keyframes with between frames to result in a smooth transition from one keyframe to the next (via the between frames) in the animation.

Today, computer-executable animation authoring applications, such as FLASH® and AFTER EFFECTS® authoring applications, aid designers in performing various animation authoring tasks, including performance of tweening. That is, such animation authoring applications provide tweening support, wherein an author can define keyframes and the authoring application can generate the between frames. So, animation authoring applications are available which are operable to perform computer generation of between frames for an animation being authored.

In general, the computer-generated tweening involves the use of a mathematical formulae to generate coordinates that can define the values of a graphical object's property(ies) over a time line. For example tweening may be performed using an interpolation technique where extra frames are generated between existing keyframes in order to produce smoother animation without requiring an author to manually draw or produce every frame of the animation.

Thus, tweening in animation authoring tools is commonly used to automatically interpolate properties between two known values at two specific times. These known value/time pairs are commonly known as “keyframes.” Animation authoring tools, such as FLASH® and AFTER EFFECTS® allow users to specify keyframes for an animation, and the tools are operable to perform tweening to “fill-in” the values for all frames between the keyframes. These calculated frames are commonly called between frames (and are referred to herein as “tween frames”).

FIGS. 1A-1C show exemplary illustrations of tweening by animation authoring tools of the prior art. FIG. 1A shows an exemplary system 10 that illustrates a first exemplary tweening technique employed by an animation authoring tool of the prior art. As shown, system 10 comprises a processor-based computer 11, such as a personal computer (PC), laptop computer, server computer, workstation computer, etc. In this example, an animation authoring tool (or “application”) 12 is executing on such a computer 11 with which a user may interact to author a graphical animation, such as exemplary graphical animation 101A shown. Animation authoring tool 12 comprises computer-executable software code stored to a computer-readable medium that is readable by a processor of computer 11 and, when executed by such processor, causes computer 11 to perform the various operations described further herein for such animation authoring application 12. Examples of such an animation authoring tool 12 known in the ait include the FLASH® and AFTER EFFECTS® authoring applications.

In the example of FIG. 1A, an author interacts with authoring tool 12 to author an animation 101A in which a bird flies across the display. It should be understood that an animation need not have spatial movement by a graphical object (e.g., the bird in this example), but may instead comprise a stationary graphical object that has certain properties (e.g., size, shape, color, orientation, etc.) that change over time. In the example, of FIG. 1A, the author specifies a motion path along which the bird moves, and the author provides keyframes key₁-key₃ at certain time points along the motion path. A timeline is provided, which illustrates a reference time over which the animation is performed. The timeline comprises fixed, linear intervals of time, such as 0 seconds, 0.25 seconds, 0.5 seconds, and so on. In this example, keyframe key₁ is arranged at time t=0 seconds in the animation, keyframe key₂ is arranged at time t=1 second in the animation, and keyframe key₃ is arranged at time t=2 seconds in the animation.

Authoring tool 12 comprises tweening logic 104 that is operable to perform tweening to generate tween frames 102₁-102₃ between keyframes key₁ and key₂ and to generate tween frames 103₁-103₃ between keyframes key₂ and key₃. By default, tweening logic 104 (e.g., computer-executable software) uses simple linear interpolation such that the calculated values for the tween frames transition smoothly between the keyframe values. Assuming the animation 101A is to have a frame rate of 4 frames per second, the time interval between each frame presented in the animation is 0.25 seconds. Thus, tween frames 102₁-102₃ are generated for presentation at times t=0.25, t=0.5, and t=0.75, respectively; and tween frames 103₁-103₃ are generated for presentation at times t=1.25, t=1.5, and t=1.75, respectively. Each of the tween frames may change the position of the bird's wings, for instance, to smoothly transition from the wing position of a first keyframe to the wing position of the next keyframe.

Tweening logic 104 performs tweening operation 105 to determine the property value(s) of each of the tween frames as a percentage of change between their respective keyframes as a function of time (according to the timeline, which has fixed, linear intervals of time). For instance, tweening logic 104 performs tweening operation 105 to determine the property value(s) of each of the tween frames 102₁-102₃ as a percentage of change between their respective keyframes key₁ and key₂; and tweening logic 104 performs tweening operation 105 to determine the property value(s) of each of the tween frames 103₁-103₃ as a percentage of change between their respective keyframes key₂ and key₃. By default, tweening operation 105 uses simple linear interpolation, as illustrated by graph 106, such that the calculated values for the tween frames transition smoothly between the keyframe values. Thus, the property value of each tween frame can be calculated according to the following formula:

TP_Value=SKP_Value+(EKP_Value−SKP_Value)*(transition_percent_of_time), wherein the TP_Value refers to the tween frame's property value being computed, the SKP_Value refers to the property value of the starting keyframe for is tween frame, the EKP_Value refers to the property value of the ending keyframe for this tween frame, and the transition_percent_of_time refers to a percentage of transition between the keyframes as a function of time. As an example, the property value for tween frame 102₁ is computed in this example as follows:
property_value_of_tween_frame_102₁=property_value_of_key₁+(property_value_of_key₂−property_value_of_key₁)*(0.25). It should be noted that graph 106 defines a linear interpolation, and thus the “0.25” value for the percentage of transition is arrived at for tween frame 102₁ as it resides at time t=0.25 on the timeline of animation 101A. Similarly, the property value for tween frame 102₂ is computed in this example as follows: property_value_of_tween_frame_102₂=property_value_of_key₁+(property_value_of_key₂−property_value_of_key₁)*(0.5). It should be noted that graph 106 defines a linear interpolation, and thus the “0.5” value for the percentage of transition is arrived at for tween frame 102₂ as it resides at time t=0.5 on the timeline of animation 101A.

The remaining tween frames are computed in a similar manner. Of course, it should be understood that tween frames 103₁-103₃ are computed based on their respective starting keyframe key₂ and ending keyframe key₃. As an example, the property value for tween frame 103₁ is computed in this example as follows:

property_value_of_tween_frame_103₁=property_value_of_key₂+(property_value_of_key₃−property_value_of_key₂)*(0.25). It should be noted that graph 106 defines a linear interpolation, and thus the “0.25” value for the percentage of transition is arrived at for tween frame 103₁ as it resides at time t=0.25 past starting keyframe key₂ (of course, because key₂ resides at time t=1 of animation 101A, tween frame 103₁ resides at time t=1.25 on the timeline of the overall animation 101A).

Tweening may be performed to generate a desired transition from one keyframe to a next keyframe for any property value differences between the keyframes, such as differences in such properties as positional location on a display, shape, size, color, etc. For instance, FIG. 1B shows another exemplary animation 101B that is being authored in animation authoring tool 12. In this example, the author has again defined keyframes key₁ and key₂. In keyframe key₂, the size of the bird is larger than that of keyframe key₁. Thus, tween frames 107₁-107₃ are generated by the authoring tool 12 for transitioning from the relatively small size of key₁ to the larger size of key₂. Tweening logic 104 again performs tweening operation 105 to determine the size property value of each of the tween frames 107₁-107₃. Again, tweening operation 105 uses simple linear interpolation, as illustrated by graph 106, such that the calculated values for the size property of the tween frames transition smoothly between the keyframe values in the manner discussed above with FIG. 1A.

FIG. 1C shows another exemplary animation 101C that is being authored in animation authoring tool 12. In this example, the author has again defined keyframes key₁ and key₂. In this example, keyframe key₁ shows an arrow, and keyframe key₂ shows the arrow rotated by 180 degrees. Thus, tween frames 108₁-108₃ are generated by the authoring tool 12 for transitioning the orientation of the arrow from that of key₁ to that of key₂. Tweening logic 104 again performs tweening operation 105 to determine the rotation (or “orientation”) property value of each of the tween frames 108₁-108₃. Again, tweening operation 105 uses simple linear interpolation, as illustrated by graph 106, such that the calculated values for the rotation property of the tween frames transition smoothly between the keyframe values in the manner discussed above with FIG. 1A.

Thus, in this example, a basic animation of rotation with two keyframes at time 0 and 1 second, with a start value of 0 degrees and an end value of 180 degrees, and a frame rate of 4 frames per second, the animation authoring tool 12 interpolates the 3 frames in between the start keyframe key₁ (at time 0 sec) and the end keyframe key₂ (at time 1 sec). With a frame rate of 4 frames per second, the time interval between frames is 0.25 seconds. When finished, the animation will have the following 5 frames. This linear interpolation is illustrated in table 1 below.

TABLE 1

| | | % | | |
|---|---|---|---|---|
| Time (sec) | Value (degrees) | transition | Frame Index | Frame Type |
| 0 | 0 | 0% | 0 | Keyframe key₁ |
| .25 | 45 | 25% | 1 | tween Frame 108₁ |
| .5 | 90 | 50% | 2 | tween Frame 108₂ |
| .75 | 135 | 75% | 3 | tween Frame 108₃ |
| 1 | 180 | 100% | 4 | Keyframe key₂ |

The linear interpolation according to the graph 106 used in the examples of FIGS. 1A-1C (where the percentage of transition in property value for each tween frame corresponds with the tween frame's corresponding point on the timeline between the two keyframes) often is not visually appealing as it may not appear natural or may otherwise fail to provide the desired transition from one keyframe to a next keyframe. “Easing” is a concept in which non-linear interpolation may be performed for tweening. That is, by employing easing users can modify the interpolation to make the animation transition between the keyframes in a non-linear fashion. In other words, easing provides a tweening technique in which the percentage of transition in property value for each tween frame need not correspond with the tween frame's corresponding point on the timeline between the two keyframes. Thus, easing may enable a great percentage of a property value change to occur over a first period of the timeline between the two keyframes, and then a smaller percentage of the property value change may occur over another period of the timeline between the two keyframes, as an example. Accordingly, when transitioning from a first property value of the starting keyframe to a second property value of the ending keyframe, easing may be employed to enable tween frames to be generated that perform the transition from the first property value to the second property value at a different rate than the corresponding timeline. For instance, with easing, the property value need not be 50% transitioned from the first value to the second value halfway along the timeline between the two keyframes. Eases are used to describe how the tween frame values are calculated by specifying the actual rate of transition between the two keyframe values. Thus, traditional easing provides a way to alter a transition as a function of time. This can be expressed as a mathematical formula, but eases can also be represented as a graph of percentage change over time.

FIGS. 2A-2B show further exemplary tweening operations of the prior art. FIG. 2A shows an exemplary system 20 that, like the examples of FIGS. 1A-1C, comprises processor-based computer 11 on which animation authoring tool 12 is executing, with which a user may interact to author a graphical animation, such as exemplary graphical animation 201A shown. In this example, an author interacts with authoring tool 12 to author an animation 201A similar to animation 101C of FIG. 1C, wherein an arrow rotates from 0 degrees to 180 degrees. Like the example of FIG. 1C, the author defines keyframe key₁ in which the arrow is oriented at 0 degrees, and the author defines keyframe key₂ in which the arrow is rotated by 180 degrees. Authoring tool 12 generates the tween frames 202₁-202₅ for transitioning from key₁ to key₂. This example assumes that the frame rate is 6 frames per second, and thus the 5 tween frames are generated, and are spaced at equal intervals along the timeline (i.e., the first tween frame 202₁ is presented at t=⅙ of the animation, the second tween frame 202₂ is presented at t= 2/6 of the animation, the third tween frame 202₃ is presented at t= 3/6 (or t=0.5) of the animation, and so on).

However, instead of the linear interpolation defined by graph 106 that is employed in tweening 105 of FIG. 1C, the example of FIG. 2A employs easing in which non-linear interpolation is defined by graph 203. As can be seen, graph 203 defines a transition in which a large percentage of the change in the property value (e.g., rotation in this example) occurs quickly (e.g., over the first half of the timeline between the keyframe), and then the remaining small percentage of change occurs more gradually over the remaining time period. Correspondingly, tween frames 202₁-202₃ rotate the arrow from 0 degrees to 135 degrees from the time t=0 to the time t=0.5, and then tween frames 202₄ and 202₅ have a more gradual change over time period t=0.5 to t=1 of the animation 201A. As such, a change of 135 degrees occurs in the first half of the timeline between the keyframes, while a further change of only 45 degrees occurs in the last half of the timeline between the keyframes. Thus, easing enables a property value change to occur in a non-linear fashion relative to the referenced timeline of the animation.

Accordingly, easing is a known concept in animation, where traditional animation authoring tools enable a user to define an ease that dictates the percentage of change between two keyframe values as a function of time. In this case, the property value for an object (e.g., value of rotation of the arrow in the example of FIG. 2A) at any frame (or time) can be obtained by looking up the percentage of transition (or, in some instances a corresponding fixed value) at a specific time according to a defined easing curve, such as curve 203 of FIG. 2A, and then applying this percentage in a formula (such as that described above in paragraph 0011) to obtain the property value for the tween frame.

FIG. 2B shows an example in which a property value curve 205 (rather than an easing curve) is employed, which defines specific values (rather than percent of transition) over time. Thus, tweening logic 104 performs tweening operation 105A in this example of FIG. 2B to determine property values (e.g., rotation value in this example) according to the plotted values over time as defined in property value curve 205 for the tween frames to be generated between keyframes key₁ and key₂ in the exemplary animation 201B. In this example, a corresponding tween frame may be generated at each vertical line shown in the property value curve 205. A portion of the generated tween frames are shown as tween frames 204₁-204₅. As can be seen, exemplary property value curve 205 defines that the object rotates from 0 degrees to 90 degrees from time t=0 seconds to time t=0.5 seconds, then the object rotates back to 45 degrees between time t=0.5 seconds to time t=0.75 seconds, and then the object rotates to 180 degrees between time t=0.75 seconds to time t=2 seconds of the animation 201B.

Easing curves, such as exemplary curve 203 of FIG. 2A, and property value curves, such as exemplary property value curve 205 of FIG. 2B, are commonly used in tweening techniques, but their use in traditional techniques have been limited and/or have had certain drawbacks. These curves are usually editable as, for instance, Bezier curves where each anchor point is considered a keyframe. Since the curve between two Bezier anchor points does not have to be linear, it can contain easing information within it. That is, a property value transition between two keyframes is dictated by the shape of the curve. Although editing the property as a curve is beneficial and makes easing an individual property easy, there are some drawbacks. One drawback is that it is difficult to ease multiple property curves identically. Also, a single ease curve cannot traditionally be applied across a plurality of keyframes, as discussed further below.

Traditionally, eases are applied between only two keyframes. If easing is desired across more than two keyframes, separate eases are traditionally required to be defined between each keyframe pair in a manner that achieves the overall desired easing in the animation. Thus, to ease an animation that contains more than two keyframes, traditional easing techniques require an author to define a separate ease curve for each span of tween frames (i.e., a separate ease is defined for determining tween frames for each pair of keyframes). For instance, for an animation having three keyframes, two ease curves are required in order to achieve easing across the full animation. For five keyframes, four ease curves are needed. One easing curve cannot traditionally be applied across a plurality of pairs of keyframes.

FIG. 3 shows an exemplary easing technique of the prior art. In this example an animation 301 is being authored which shows a bird flying across the output display, similar to that of FIG. 1A. In this example, keyframes key₁, key₂, and key₃ are defined. Thus, 2 pairs of keyframes are defined for the animation: pair 1 is (key₁, key₂), and pair 2 is (key₂, key₃), Suppose that the author desires to have easing applied to the full animation (i.e., across the plurality of pairs of keyframes) to achieve an effect in which a property change appears to transition slowly (or by a small degree) during a first portion of the animation 301 (e.g., from time t=0 to time t=0.5), then transition more rapidly (or to a greater degree) during a middle portion of the animation 301 (e.g., from time t=0.5 to time t=1.5), and finally transition slowly (or by a small degree) during a last portion of the animation 301 (e.g., from time t=1.5 to time t=2). For instance, it may be desired for the bird to begin by moving slowly along its motion path, then move more quickly, and finally end with again moving slowly along its motion path.

Thus, the author desires for the easing effect to span across multiple pairs of key frames. Accordingly, tweening logic 104 performs tweening operations 105₁ and 105₂ to generate tween frames between keyframes key₁ and key₂ and between keyframes key₂ and key₃, respectively. A portion of the tween frames that are generated between keyframes key₁ and key₂ are shown as tween frames 302₁-302₃ (which are indicative of the tween frames in which the greatest change in the property value occurs); and a portion of the tween frames that are generated between keyframes key₂ and key₃ are shown as tween frames 303₁-303₃ (which are again indicative of the tween frames in which the greatest change in the property value occurs between these keyframes). To achieve the desired effect, the author specifies a first curve 304 that tween operation 105₁ is to employ for generating tween frames between key₁ and key₂ such that the transition in the property value change initially transitions gradually and then more rapidly (or to a greater extent) toward the end of the time period (between key₁ and key₂). This type of easing curve is commonly referred to as an “ease in” curve. The author further specifies a second curve 305 that tween operation 105₂ is to employ for generating tween frames between key₂ and key₃ such that the transition in the property value change initially transitions rapidly (or to a greater extent) and then more gradually (or to a lesser extent) toward the end of the time period (between key₂ and key₃). This type of easing curve is commonly referred to as an “ease out” curve. Accordingly, the user is required to specify 2 separate ease curves 304 and 305 for the 2 keyframe pairs in order to achieve the desired overall easing effect.

Accordingly, a desire exists for an improved technique for performing certain computer-generation animation effects across a plurality of keyframe pairs. As one example, a desire exists for an improved technique for defining a desired easing for a tween, which preferably enables application of such easing across a plurality of keyframe pairs.

### SUMMARY

The present invention is directed to systems and methods which employ time re-mapping for use in computer-generated animation. According to certain embodiments of the present invention, a time re-mapper is utilized to re-map at least a portion of an animation's reference timeline to produce a different timeline. In this way the, the re-mapping may enable a re-mapped timeline to be generated that is non-linear. The animation's reference timeline refers to a linear timeline that reflects an actual progression of time (e.g., the amount of time between values t=0 second and t=1 second is 1 second), whereas the re-mapped timeline modifies the animation's reference timeline in some way (e.g., changing the point in time at which t=1 second occurs such that the period between t=0 and t=1 is not 1 second in the re-mapped timeline). The animation may be performed over its corresponding reference timeline (e.g., an animation defined to occur over a 3 second period of the reference timeline actually occurs over such 3 second period), but a re-mapped timeline may be generated that defines a non-linear advancement of time along the reference timeline. The re-mapped timeline may then be employed by animation generation logic that generates some effect in the animation as a function of time. For instance, the re-mapped time may be used (e.g., in place of the animation's reference timeline) by tweening logic for generating tween frames in the animation. As discussed above, traditional tweening logic generates tween frames having some property value as a unction of time, and thus the re-mapped time may be supplied to the tweening logic and the tweening logic may generate its tween frames as a function of the re-mapped time. Thus, the re-mapping may be employed to effectively produce such animation effects as easing for the generated tween frames, as discussed further herein.

According to certain embodiments, a time re-mapper is provided that effectively revises the animation's reference timeline for purposes of generating some effect in animation. For instance, a time mapping function (e.g., curve) can be defined that re-maps (or redefines) the animation's reference timeline to a non-linear timeline for purposes of generating an effect in the animation, such as for use in generating tween frames. Thus, certain animation generating logic generates some animation effect as a function of time, such as the above-described tweening logic which generates transition property values of tween frames as a function of time, and certain embodiments of the present invention enable the time function employed by the animation generating logic to be altered in a way that results in a desired animation effect. That is, the reference timeline of the animation is re-mapped to produce a new (e.g., non-linear) timeline for use by animation generating logic (e.g., tweening logic) in generating some effect in the animation (e.g., determining transition property values for tween frames) based on the new timeline.

By re-mapping the time function on which the animation generating logic is based, certain animation effects can be easily achieved. For instance, instead of (or in addition to) tweening logic employing an easing curve for determining at any given point in time between two keyframes a percentage of transition of a property value of a graphical object, the time re-mapping provides an easy technique for achieving easing. For example, certain embodiments of the present invention enable an easing effect to be achieved by determining property value(s) for each tween frame without being required to know the keyframe property values or altering the percentage of transition between the keyframe values, but instead the time re-mapper can define how to sample the property value over time according to a re-mapped (e.g., non-linear) time flow.

Thus, rather than (or in addition to) attempting to define an easing curve that specifies the rate at which a property value transitions as a function of time, a time re-mapper may be employed in accordance with embodiments of the present invention for re-mapping the animation's reference timeline to a new timeline (e.g., non-linear timeline) that is then used by the tweening logic. By effectively re-mapping the animation's reference timeline to a new non-linear timeline that is used by the tweening logic, an easing effect can be achieved. Further, the easing effect can be applied across a plurality of different keyframe pairs. That is, the re-mapping may produce a new timeline for all or a portion of an animation which may span a plurality of keyframe pairs. Also, the time re-mapping technique of embodiments of the present invention may be employed in addition to traditional easing techniques that may be employed for individual keyframe pairs. For instance, suppose that traditional easing techniques are employed for individual keyframe pairs, and then suppose that the animation author desires to apply a further easing across the plurality of keyframe pairs; the author may utilize the time re-mapping technique of embodiments of the present invention to achieve the further easing that can be applied across the plurality of keyframe pairs.

According to one embodiment, the animation's reference time value is input to a time re-mapper, which determines a new time value according to a defined time mapping function (or “curve”). The time mapping function may be implemented as a formula or as a curve that represents some formula. For instance, the time mapping function may be represented by a curve on a graph in which the X axis corresponds to time values of the animation's reference timeline and the Y axis corresponds to a new, re-mapped time value. For example, time value t=0.5 of the animation's reference timeline may be input the time re-mapper, which determines from the time mapping function that such time value t=0.5 is to be mapped to actually occur at time t=1 second. Thus, according to one embodiment, when animation generation logic (e.g., tweening logic) queries a graphical object's property value in time, it does not query the property value as a function of the animation's reference timeline, but instead runs the animation's reference time value through the time re-mapper and the animation generation logic queries the graphical object's property value based on the re-mapped time value.

Further, a given time re-mapping may be defined for use for all or any number of properties of a graphical object in an animation. According to certain embodiments, different time re-mapping functions may be employed for different properties of a graphical object in an animation. Thus, a time re-mapping may be determined on a property-by-property basis according to certain embodiments. Further, different time re-mapping functions may be employed for different portions of a given animation. For instance, a first time re-mapping function may be employed for re-mapping a first portion of the animation's reference timeline (e.g., the first 5 seconds of the animation's reference timeline) and a second time re-mapping function may be employed for re-mapping a second portion of the animation's reference timeline (e.g., the second 5 seconds of the animation's reference timeline). Further, according to certain embodiments of the present invention, the time re-mapping may be layered such that a first re-mapped time may be input to another time re-mapper which further re-maps the first re-mapped time to a second re-mapped time. As an example, suppose that the first and second time re-mapping functions are applied to first and second portions of an animation, as mentioned above, the author may further apply an easing effect (or other desired effect) to the overall animation (e.g., to both the first and second portions of the animation) by inputting the first and second re-mapped times to a third re-mapping function that produces a new re-mapped time to be applied to the overall animation. Accordingly, the reference time value input to the time re-mapper may be the animation's reference timeline, or in some instances, it may be a previously determined re-mapped time value.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the present invention, reference is now made to the following descriptions taken in conjunction with the accompanying drawing, in which:

FIGS. 1A-1C show exemplary illustrations of tweening by animation authoring tools of the prior at:

FIGS. 2A-2B show further exemplary tweening operations of the prior art;

FIG. 3 shows an exemplary easing technique of the prior art;

FIG. 4 shows an exemplary system according to one embodiment of the present invention;

FIG. 5 shows an exemplary system that illustrates a specific exemplary easing application of the time re-mapper according to one embodiment of the present invention;

FIG. 6 shows an exemplary system that illustrates another specific exemplary easing application of the time re-mapper according to one embodiment of the present invention;

FIG. 7 shows an exemplary system that illustrates yet another specific exemplar animation generation application of the time re-mapper according to one embodiment of the present invention;

FIG. 8 shows a system which illustrates a farther exemplary application according to an embodiment of the present invention;

FIG. 9 shows an exemplary operational flow diagram according to one embodiment of the present invention; and

FIG. 10 shows an exemplary system on which animation authoring tool may be implemented according to one embodiment of the present invention

### DETAILED DESCRIPTION

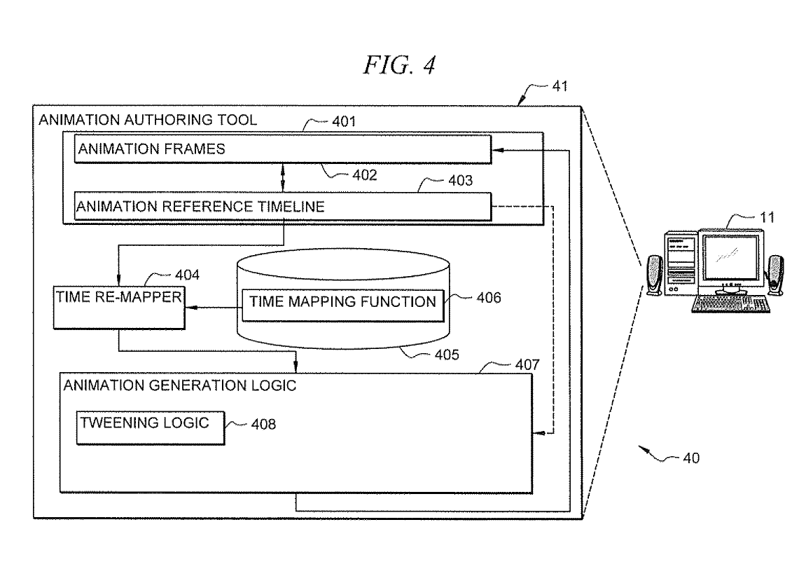

Turning to FIG. 4, an exemplary system 40 according to one embodiment of the present invention is shown. As shown, system 40 comprises a processor-based computer 11, such as a personal computer (PC), laptop computer, server computer, workstation computer, etc. In this example, an animation authoring tool (or “application”) 41 is executing on such a computer 11. While animation authoring tool 41 is shown as executing on computer 11 for ease of illustration in FIG. 4, it should be recognized that such tool may be residing and/or executing either locally on computer 11 or on a remote computer to which computer 11 is communicatively coupled via a communication network, such as a local area network (LAN), the Internet or other wide area network (WAN), etc.

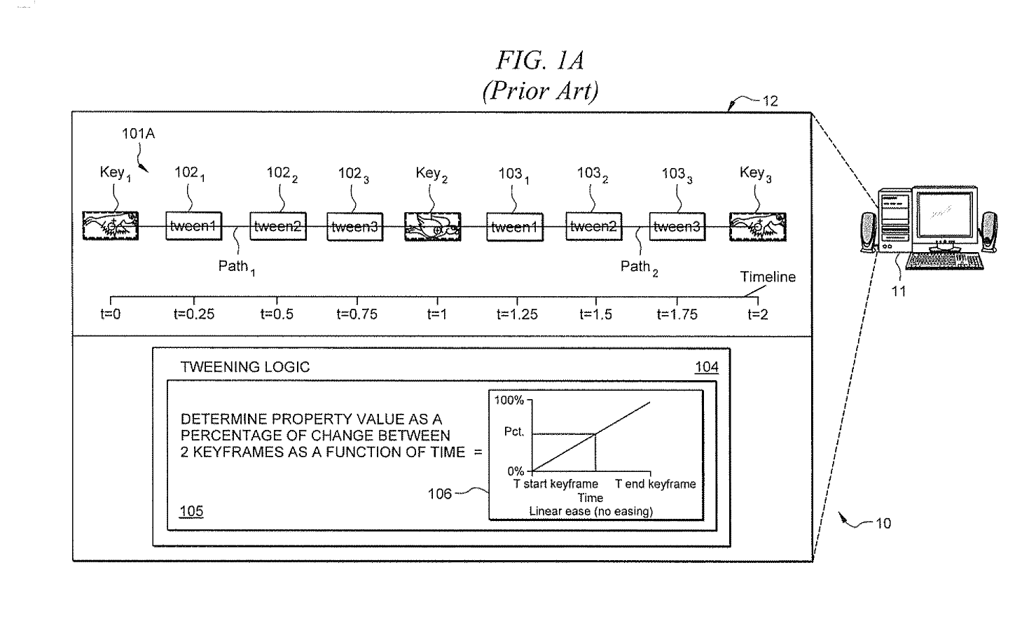

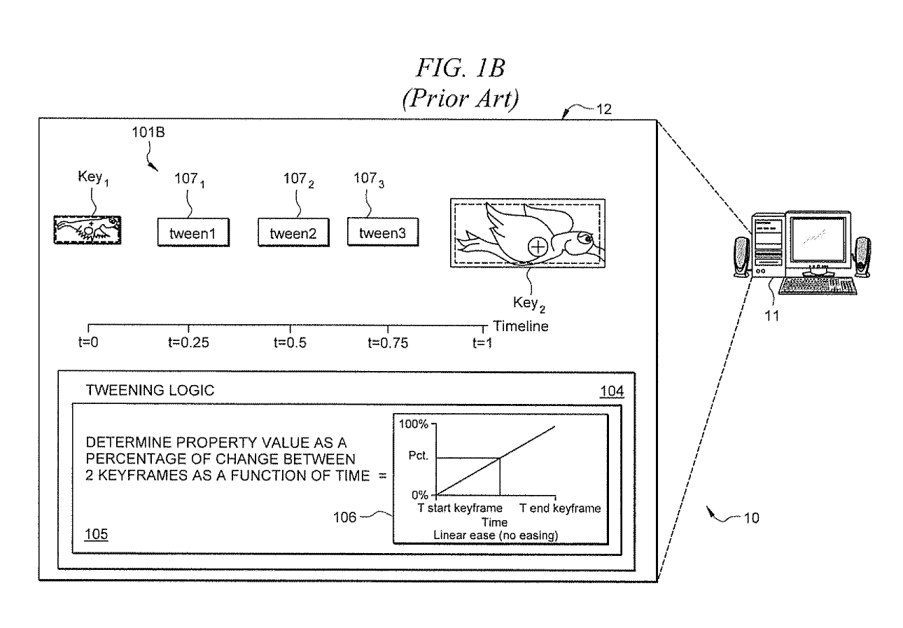

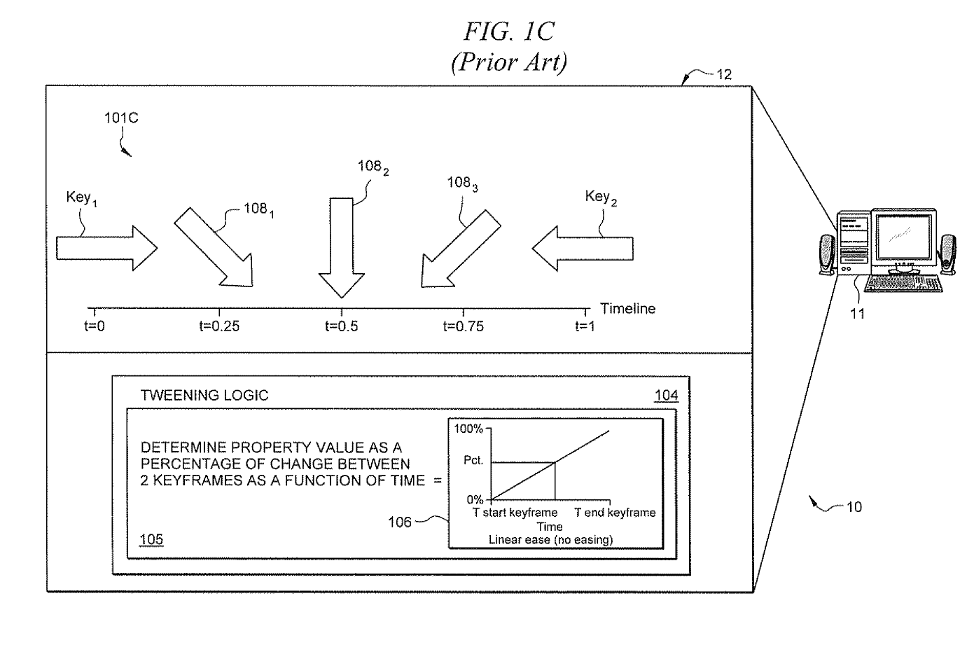

As with the exemplary animation authoring tool 12 described above with FIGS. 1-3, animation authoring tool 41 comprises computer-executable software code stored to a computer-readable medium that is readable by a processor of computer 11 and, when executed by such processor, causes computer 11 to perform the various operations described further herein for such animation authoring tool 41. Examples of such an animation authoring tool 41 include FLASH® and AFTER EFFECTS® animation authoring applications.

As with the traditional animation authoring tool 12 described above, animation authoring tool 41 enables authoring of an animation, such as creating, modifying, and/or otherwise authoring an animation. That is, a user can interact with animation authoring tool 41 to author an animation. Accordingly, animation authoring tool 41 presents a user interface (e.g., to a display of computer 11) with which a user may interact (e.g., via user input devices, such as a keyboard, mouse, etc. of computer 11) for authoring an animation. Further, animation authoring tool 41 may aid the author in generating (e.g., via animation generation logic 407) certain aspects of the animation, such as in generating (via tweening logic 408) tween frames of the animation, as discussed above. In the illustrated example of FIG. 4, an exemplary animation 401 is being authored. Animation 401 comprises a plurality of animation frames 402 that are presented according to a reference timeline 403 of the animation.

According to this exemplary embodiment, animation authoring tool 41 includes time re-mapper 404. According to certain embodiments, time re-mapper 404 comprises computer-executable software code stored to a computer-readable medium that is readable by a processor of computer 11 and, when executed by such processor, causes computer 11 to perform the various operations described further herein for such time re-mapper 404. Time re-mapper 404 is operable to re-map the animation's reference timeline 403 to generate a new timeline (i.e., a re-mapped timeline) according to a time mapping function 406. According to certain embodiments, time mapping function 406 comprises computer-readable data stored to a computer-readable medium, such as data storage 405, that is readable by time re-mapper 404.

The re-mapped time values generated by time re-mapper 404 are supplied to animation generation logic 407, such as greening logic 408, for use in generating certain effects in the animation 401 as a function of such re-mapped time values. For instance, tween frames may be generated by tweening logic 408 for inclusion in animation frames 402, wherein tweening logic 408 determines certain property values of the generated tween frames as a function of the re-mapped time values supplied by time re-mapper 404. Of course, as shown by the dashed arrow in FIG. 4, in some instances the actual animation reference timeline may be supplied to certain animation generation logic. Thus, for example, tweening certain property values may be performed based on the actual animation reference timeline 403, while tweening operations for other property values of a graphical object may be performed based on the re-mapped time output by time re-mapper 404.

Thus, according to certain embodiments of the present invention, time re-mapper 404 is utilized to re-map at least a portion of the animation's reference timeline 403 to produce a different timeline. In this way the, the re-mapping may enable a re-mapped timeline to be generated that is non-linear. For example, the re-mapping performed by re-mapper 404 according to the time mapping function 406 may result in a non-linear timeline, such as one in which a greater delay than 1 second between the time values t=0 second and tell second of the animation's reference timeline 403. The animation's reference timeline 404 generally refers to a linear timeline that reflects an actual progression of time (e.g., the amount of time between values t=0 second and t=1 second is 1 second), whereas the re-mapped timeline generated by re-mapper 404 modifies the animation's reference timeline 403 in some way (e.g., changing the point in time at which t=1 second occurs such that the period between t=0 and t=1 is not 1 second in the re-mapped timeline).

The re-mapped timeline generated by re-mapper 404 may then be employed by animation generation logic 407 that generates some effect in the animation 401 as a function of time. For instance, the re-mapped time may be used (e.g., in place of the animation's reference timeline 403) by tweening logic 408 for generating tween frames in the animation's frames 402. As discussed above, traditional tweening logic generates tween frames having some property value as a function of time, and thus the re-mapped time may be supplied to the tweening logic 408 and the tweening logic 408 may generate its tween frames as a function of the re-mapped time. Thus, the re-mapping may be employed to effectively produce such animation effects as easing for the generated tween frames, as discussed further below.

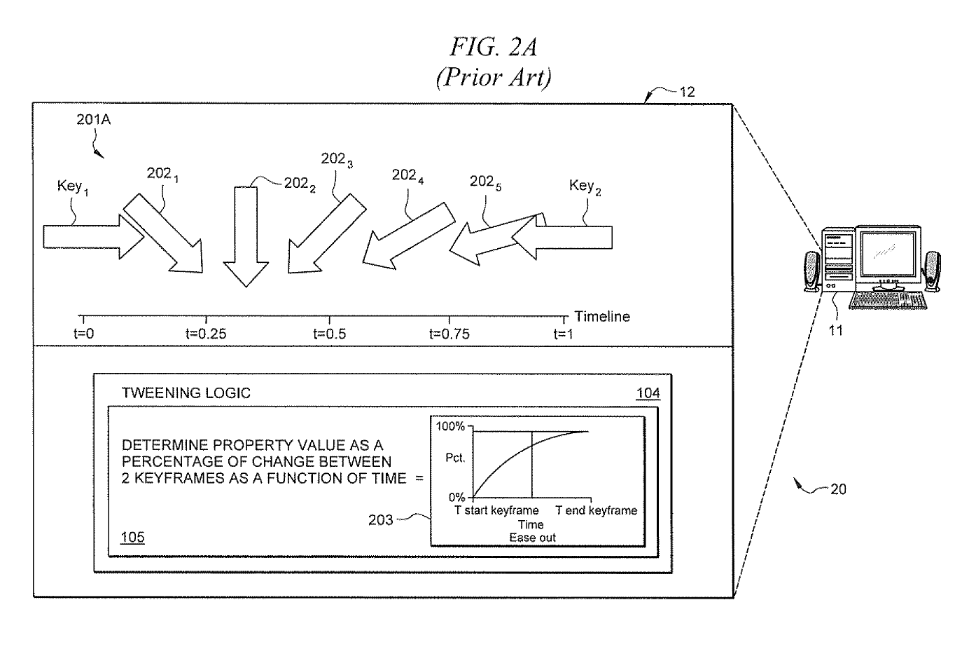

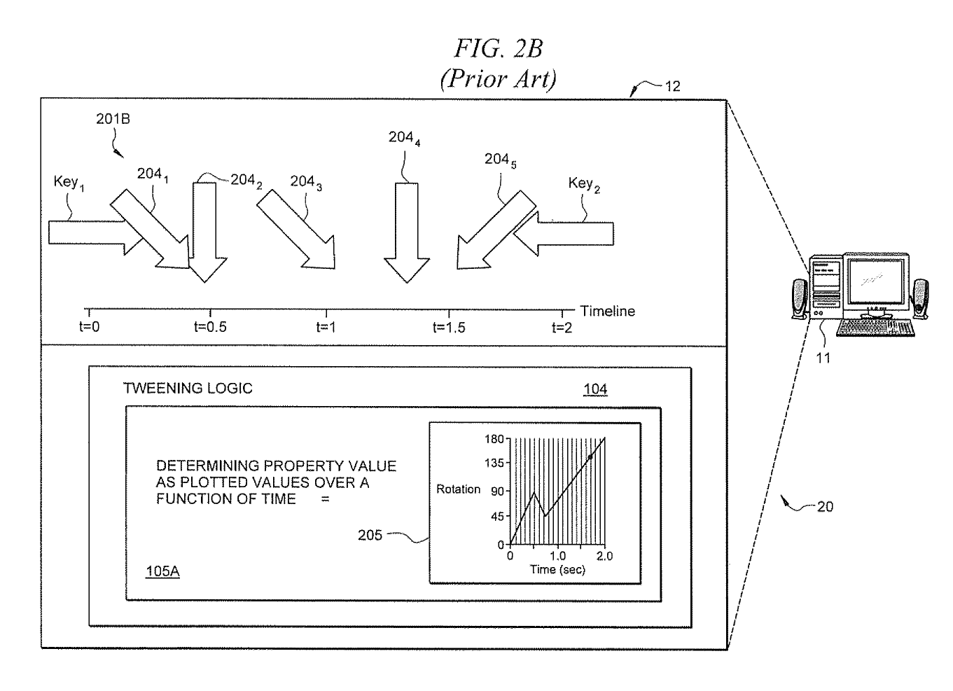

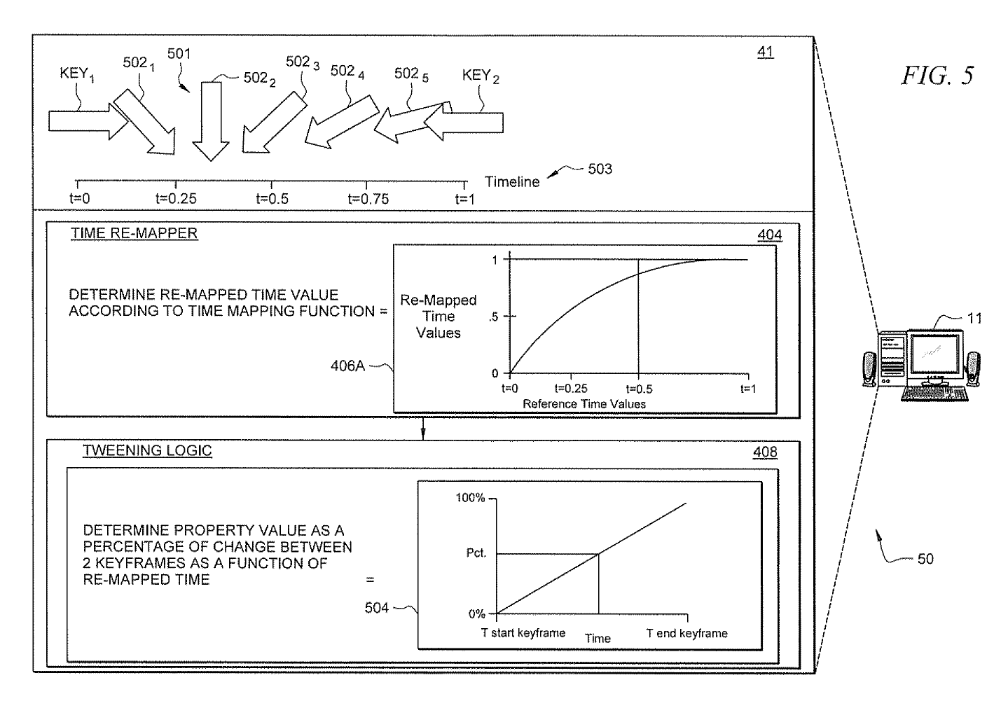

Turning now to FIG. 5, an exemplary system 50 illustrates a specific exemplary easing application of the time re-mapper according to one embodiment of the present invention. Again, animation authoring tool 41 is executing on computer 11. In this example, an animation 501 is being authored, in which the author desires for an arrow to rotate from 0 degrees to 180 degrees from time t=0 to time t=1 of the animation reference timeline 503. However, similar to the example discussed above with FIG. 2A, an easing effect is desired in which a great amount of the transition from 0 degrees to 180 degrees occurs early in the reference timeline 503 (such that it appears that the arrow initially rotates rapidly and then slows its rotation toward the end of the timeline 503). As discussed below, time re-mapper 404 may be employed to achieve the desired easing effect, instead of the tweening logic employing an easing curve (such as the easing curve 203 employed in the example of FIG. 2A).

Like the example of FIG. 2A, the author defines keyframe key₁ in which the arrow is oriented at 0 degrees, and the author defines keyframe key₂ in which the arrow is rotated by 180 degrees. The author then specifies a time re-mapping function 406A to be employed by time re-mapper 404. As shown in this example, time re-mapping function 406A maps reference time values (of the animation's timeline 503) to re-mapped time values, thereby effectively producing a new, non-linear timeline. For instance, as shown, exemplary time re-mapping function 406A produces a non-linear timeline in which time initially advances very quickly and then slows. For example, the time value t=0.25 of reference timeline 503 is mapped to time t=0.5 in the new, re-mapped timeline. Thus, the new re-mapped timeline effectively speeds-up time such that time advances to t=0.5 during the time period t=0 to t=0.25 of the animation's reference timeline 503 (i.e., time moves twice as fast during this first part of the re-mapped timeline as it does in reference timeline 503). Similarly, the time value t=0.5 of reference timeline 503 is mapped to approximately time t=0.9 in the new, re-mapped timeline. Thus, the new re-mapped timeline effectively speeds-up time such that time advances to t=0.9 during the time period t=0 to t=0.5 of the animation's reference timeline 503. Time re-mapping fiction 406A then effectively slows time in the re-mapped timeline, wherein the mapping dictates that the re-mapped timeline advances from approximately t=0.9 to t=1 during the last half of the reference timeline's values (i.e., from t=0.5 to t=1 of reference timeline 503).

The re-mapped time generated according to re-mapping function 406A is supplied to tweening logic 408, which employs a linear function 504 for performing the tweening as a function of the re-mapped time. Thus, rather than employing an easing curve, tweening logic 408 may employ linear function 504, but easing is still achieved because of the re-mapped time on which the tweening is based. Thus, the tweening logic 408 generates tween frames 502₁-502₅ for transitioning from key₁ to key₂. This example assumes that the frame rate is 6 frames per second, and thus the 5 tween frames are generated, and are spaced at equal intervals along the animation's reference timeline 503 (i.e., the first tween frame 502₁ is presented at t=⅙ of the animation, the second tween frame 502₂ is presented at t= 2/6 of the animation, the third tween frame 502₃ is presented at t= 3/6 (or t=0.5) of the animation, and so on).

However, because the tweening logic 408 performs its linear interpolation (as defined by graph 504) as a function of the re-mapped time generated according to time re-mapping function 406A, easing is achieved (as illustrated) in the transition from 0 degrees to 180 degrees, whereby a large percentage of the change in the property value (e.g., rotation in this example) occurs quickly (e.g., over the first half of the animation's reference timeline 503), and then the remaining small percentage of change occurs more gradually over the remaining time period. Correspondingly, tween frames 502₁-502₃ rotate the arrow from 0 degrees to 135 degrees from the animation's reference time t=0 to the time t=0.5, and then tween frames 502₄ and 502₅ have a more gradual change over the animation's reference time period t=0.5 to t=1 of the animation 501. As such, a change of 135 degrees occurs in the first half of the animation's reference timeline 503, while a further change of only 45 degrees occurs in the last half of the animation's reference timeline 503. This easing is achieved because the tweening is performed by tweening logic 408 as a function of the re-mapped time generated by time re-mapper 404 (according to re-mapping function 406A), rather than performing such tweening as a function of the animation's actual reference timeline 503.

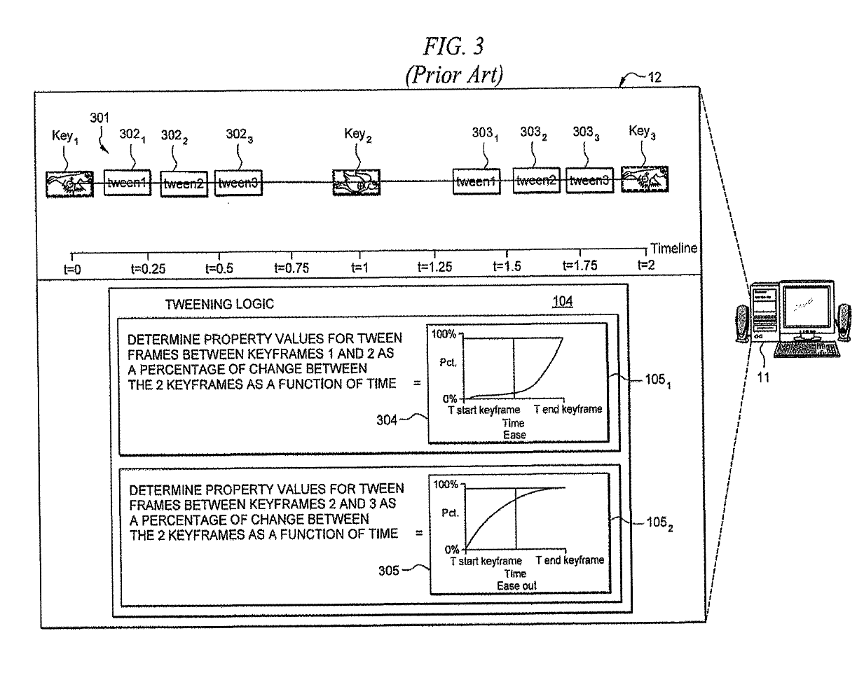

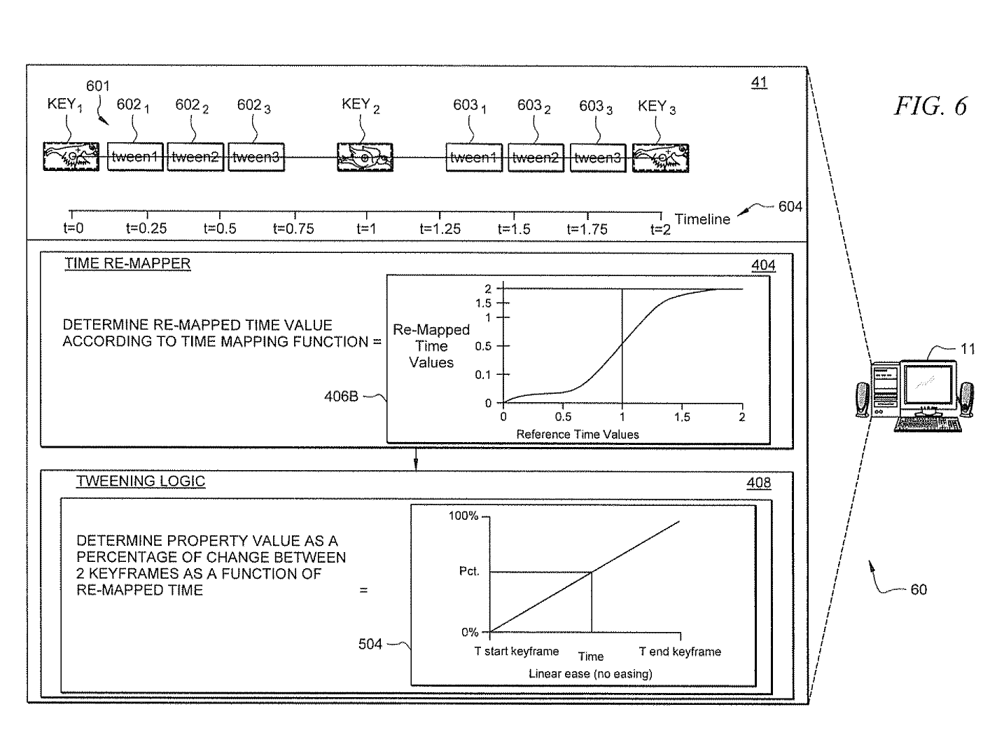

Turning now to FIG. 6, an exemplary system 60 illustrates another specific exemplary easing application of the time re-mapper according to one embodiment of the present invention. Again, animation authoring tool 41 is executing on computer 11. In this example, an animation 601 (similar to animation 301 of FIG. 3) is being authored, in which the author desires for a bird to fly across an output display from time t=0 to time t=2 of the animation reference timeline 604. As in the example of FIG. 3, keyframes key₁, key₂, and key₃ are defined. Thus, 2 pairs of keyframes are defined for the animation; pair 1 is (key₁, key₂), and pair 2 is (key₂, key₃). Also, as in the example of FIG. 3, the author desires to have easing applied to the full animation (i.e., across the plurality of pairs of keyframes) to achieve an effect in which a property change appears to transition slowly (or by a small degree) during a first portion of the animation 601 (e.g., from animation reference time t=0 to time t=0.5), then transition more rapidly (or to a greater degree) during a middle portion of the animation 601 (e.g., from animation reference time t=0.5 to time t=1.5), and finally transition slowly (or by a small degree) during a last portion of the animation 601 (e.g., from animation reference time t=1.5 to time t=2). For instance, it may be desired for the bird to begin by flapping its wings slowly, then flapping them more quickly, and finally end with again flapping its wings slowly.

Thus, the author desires for the easing effect to span across multiple pairs of key frames. According to an embodiment of the present invention, the time re-mapping technique may be employed to enable the desired easing effect to be achieved across the plurality of keyframe pairs, rather than requiring an author to define separate easing curves for each keyframe pair in the traditional manner described above with FIG. 3. For instance, in this example, the author specifies a time re-mapping function 406B to be employed by time re-mapper 404. As shown in this example, time re-mapping function 406B maps reference time values (of the animation's timeline 604) to re-mapped time values, thereby effectively producing a new, non-linear timeline. For instance, as shown, exemplary time re-mapping function 406B produces a non-linear timeline in which time initially advances very slowly, then advances very quickly, and then slows again. For example, the time value t=0.5 of reference timeline 604 is mapped to time t=0.1 in the new, re-mapped timeline. Thus, the new re-mapped timeline effectively slows down time such that time advances only to t=0.1 during the time period t=0 to t=0.5 of the animation's reference timeline 604. The curve of time re-mapping function 406B then effectively speeds-up time in the re-mapped time such that the re-mapped timeline advances from time t=0.1 to t=1.9 during the period of t=0.5 to t=1.5 of the animation's reference timeline 604 (i.e., time advances by 1.8 seconds in the re-mapped timeline during the 1-second period of 0.5-1.5 of the animation's reference timeline 604). The curve of time re-mapping function 406B then again slows time in the re-mapped time such that the re-mapped timeline advances from time t=1.9 to t=2 during the period of t=1.5 to t=2 of the animation's reference timeline 604.

The re-mapped time generated according to re-mapping function 406B is supplied to tweening logic 408, which employs a linear function 504 for performing the tweening as a function of the re-mapped time. Thus, rather than employing easing curves (as in the traditional technique of FIG. 3), tweening logic 408 may employ linear function 504, but easing is still achieved because of the re-mapped time on which the tweening is based. Further, the easing is achieved across the plurality of keyframe pairs without requiring separate easing curves to be defined for the separate keyframe pairs (as in the traditional technique of FIG. 3). Thus, the tweening logic 408 generates tween frames between keyframes key₁ and key₂ and between keyframes key₂ and key₃, respectively. A portion of the tween frames that are generated between keyframes key₁ and key₂ are shown as tween frames 602₁-602₃ (which are indicative of the tween frames in which the greatest change in the property value occurs); and a portion of the tween frames that are generated between keyframes key₂ and key₃ are shown as tween frames 603₁-603₃ (which are again indicative of the tween frames in which the greatest change in the property value occurs between these keyframes).

Because the tweening logic 408 performs its linear interpolation (as defined by graph 504) as a function of the re-mapped time generated according to time re-mapping function 406B, easing is achieved (as illustrated) in the animation such that transition in property value(s) (e.g., the change in the bird's shape to reflect its wings flapping) occurs slowly initially, then more quickly during the middle portion of the animation 601, and then slowly again at the end of the animation, as desired. This easing is achieved because the tweening is performed by tweening logic 408 as a function of the re-mapped time generated by time re-mapper 404 (according to re-mapping function 406B), rather than performing such tweening as a function of the animation's actual reference timeline 604.

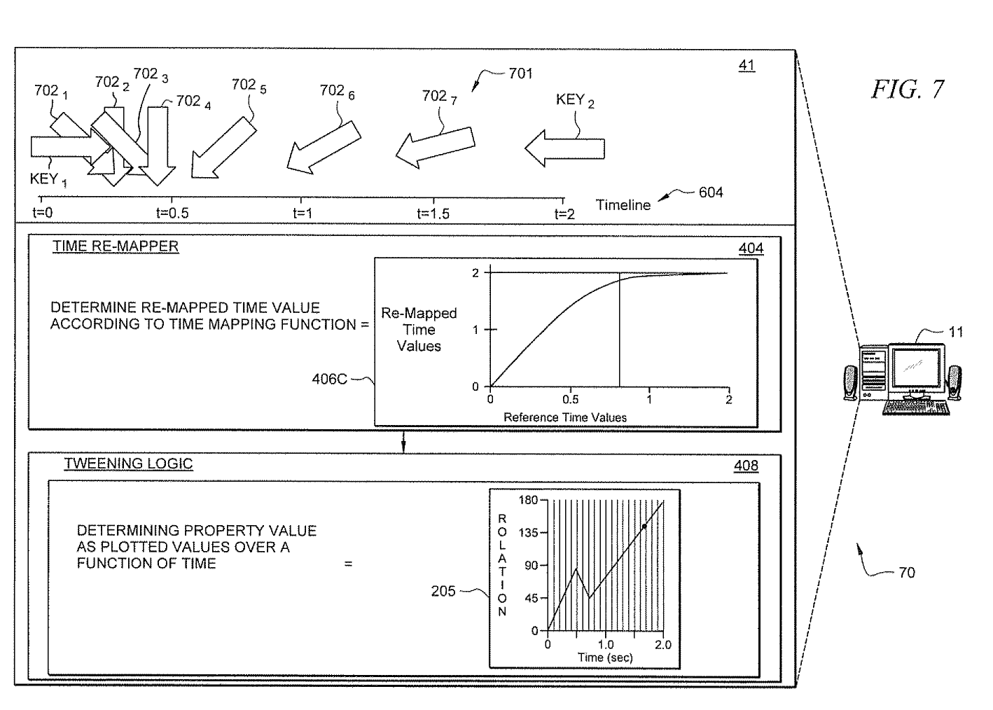

Turning to FIG. 7, an exemplary system 70 illustrates yet another specific exemplary animation generation application of the time re-mapper according to one embodiment of the present invention. Again, animation authoring tool 41 is executing on computer 11. In this example, an animation 701 (similar to animation 201B of FIG. 2B) is being authored, in which the author desires for an arrow to rotate from 0 degrees to 180 degrees according to the property value curve 205 of tweening logic 408. Thus, tweening logic 408 performs its tweening operation in this example to determine property values (e.g., rotation value in this example) for tween frames 702₁-702₇ according to the plotted values over time as defined in property value curve 205. In this example, tweening logic 408 generates a corresponding tween frame at each vertical line shown in the property value curve 205. A portion of the generated tween frames are shown as tween frames 702₁-702₇. As can be seen, in this example, property value cure 205 defines that the object rotates from 0 degrees to 90 degrees from time t=0 seconds to time t=0.5 seconds, then the object rotates back to 45 degrees between time t=0.5 seconds to time t=0.75 seconds, and then the object rotates to 180 degrees between time t=0.75 seconds to time t=2 seconds.

According to this exemplary application, the animation author desires an easing effect in which a great amount of the transition (according to property value curve 205) occurs early in the animation's reference timeline 604 (such that it appears that the arrow initially rotates rapidly and ten slows its rotation toward the end of the timeline 604). As discussed below, time re-mapper 404 may be employed to achieve the desired easing effect. That is, time re-mapper 404 is employed to re-map the time values of the animation's reference timeline 604 to generate a new, re-mapped timeline according to time mapping function 406C.

The re-mapped time generated according to re-mapping function 406C is supplied to tweening logic 408, which employs property value cure 205 for performing the tweening as a function of the re-mapped time. Thus, the desired easing is achieved in the animation because of the re-mapped time on which the tweening is based. For instance, as shown, approximately 90% of the transition defined in property value curve 205 is performed during the first half of the animation's reference timeline 604, and the remaining 10% of the transition defined in property value curve 205 occurs over the last half of the animation's reference timeline 604. This easing is achieved because the tweening is performed by tweening logic 408 as a function of the re-mapped time generated by time re-mapper 404 (according to re-mapping function 406C), rather than performing such tweening as a function of the animation's actual reference timeline 604.

According to embodiments of the present invention, a given time re-mapping may be defined for use for all or any number of properties of a graphical object in an animation. According to certain embodiments, different time re-mapping functions may be employed for different properties of a graphical object in an animation. For instance, time re-mapping function 406B may be employed for a transition in one property of an object, such as its rotation, while a different time re-mapping function 406C may be employed for a transition in another property of the object, such as its shape. Thus, a time re-mapping may be determined on a property-by-property basis according to certain embodiments.

Further, different time re-mapping functions may be employed for different portions of a given animation. For instance, a first time re-mapping function may be employed for re-mapping a first portion of the animation's reference timeline (e.g., the first 5 seconds of the animation's reference timeline) and a second time re-mapping function may be employed for re-mapping a second portion of the animation's reference timeline (e.g., the second 5 seconds of the animation's reference timeline). Further, according to certain embodiments of the present invention, the time re-mapping may be layered such that a first re-mapped time may be input to another time re-mapper which further re-maps the first re-mapped time to a second re-mapped time. As an example, suppose that the first and second time re-mapping functions are applied to first and second portions of an animation, as mentioned above, the author may further apply an easing effect (or other desired effect) to the overall animation (e.g., to both the first and second portions of the animation) by inputting the first and second re-mapped times to a third re-mapping function that produces a new re-mapped time to be applied to the overall animation. Accordingly, the reference time value input to the time re-mapper may be the animation's reference timeline, or in some instances, it may be a previously determined re-mapped time value.

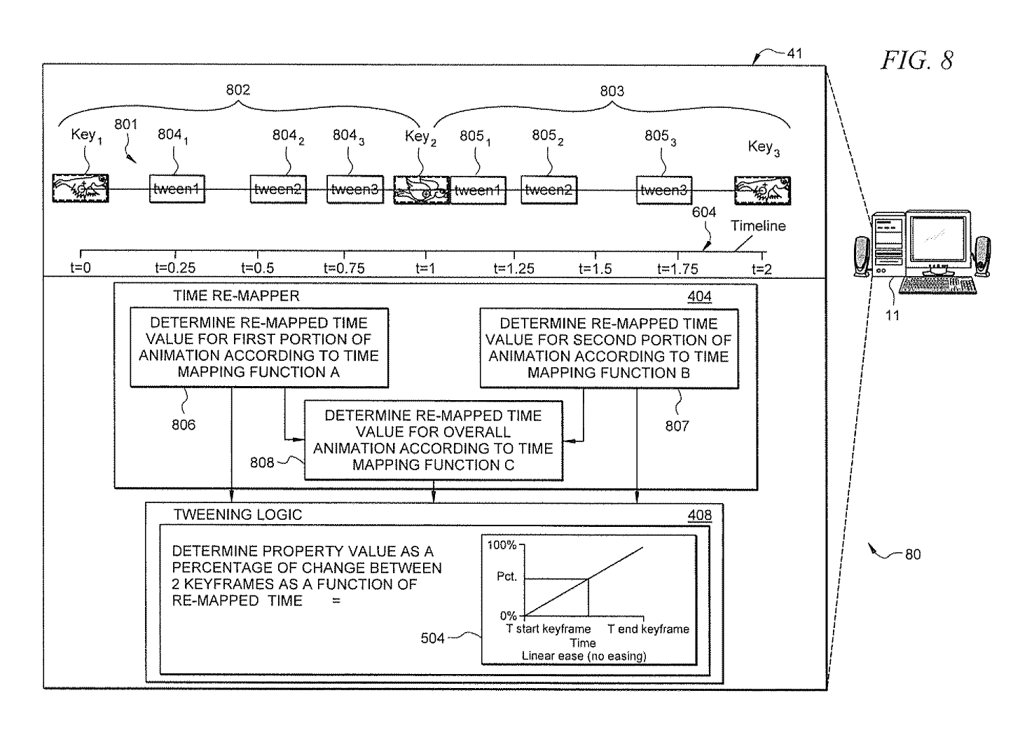

As an example, FIG. 8 shows a system 80 which illustrates a further exemplary application according to an embodiment of the present invention. Again, animation authoring tool 41 is executing on computer 11. In this example, an animation 801 is being authored, in which the author desires for a bird to fly across an output display. The author has defined 3 keyframes key₁-key₃. In this example, the author has specified (via an interface provided by animation authoring tool 41) different time re-mapping functions to be employed for different portions of animation 801. For instance, a first time re-mapping function is employed in operational block 806 of time re-mapper 404 for re-mapping a first portion 802 of the animation's reference timeline 604 (i.e., the first second of the animation's reference timeline in this example). For example, operational block 806 may employ a first time re-mapping function, such as function 406B, for portion 802 of the animation 801. A second time re-mapping function is employed in operational block 807 of time re-mapper 404 for re-mapping a second portion 803 of the animation's reference timeline 604 (i.e., the period from t=1 to t=2 of the animation's reference timeline in this example). For example, operational block 807 may employ a second time re-mapping function, such as function 406C, for portion 803 of the animation 801.

The re-mapped time values from operational block 806 may be supplied to tweening logic 408 to cause a desired easing (in the manner described above) for the first portion 802 of the animation 801. Similarly, the re-mapped time values from operational block 807 may be supplied to tweening logic 408 to cause a different desired easing (in the manner described above) for the second portion 803 of the animation 801.

Further, according to certain embodiments of the present invention, the time re-mapping may be layered such that a first re-mapped time values may be input to another time re-mapper which further re-maps the first re-mapped time to a second re-mapped time. As an example, suppose that after the first and second time re-mapping functions (of operational blocks 806 and 807) are applied to first and second portions (802 and 803, respectively) of animation 801, as mentioned above, the author desires to apply an easing effect (or other desired effect) to the overall animation 801 (e.g., to both the first and second portions 802-803 of the animation). The author may easily achieve the desired easing by defining a further time re-mapping 808 which receives as input the re-mapped time values produced by the operational blocks 806 and 807 and produces (according to a specified time mapping function) a new re-mapped time to be applied to the overall animation. Thus, the new re-mapped time value produced by operational block 808 may be input to tweening logic 408, and tweening logic 408 may generate the tween frames based on such new re-mapped time value, which will result in the desired overall easing effect in the animation 801.

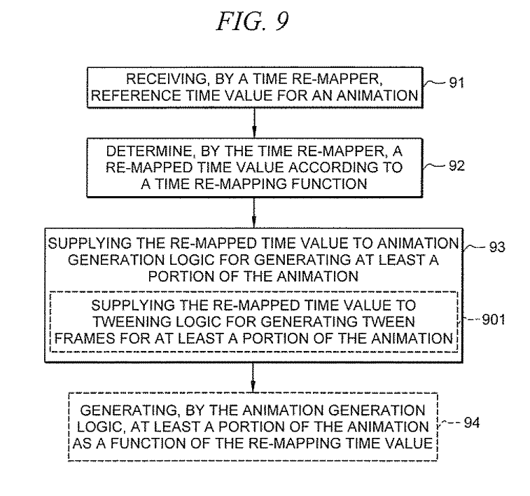

FIG. 9 shows an exemplary operational flow diagram according to one embodiment of the present invention. In operational block 91, a time re-mapper 404 receives a reference time value for an animation (e.g., time values from an animation's reference timeline). In block 92, the time re-mapper determines a re-mapped time value according to a time re-mapping function. In block 93, the re-mapped time value is supplied to animation generation logic for generating at least a portion of the animation. For instance, in certain embodiments, as shown in sub-block 901, the re-mapped time value is supplied to tweening logic for generating tween frames for at least a portion of the animation based on the re-mapped time value. In certain embodiments, as indicated in optional block 94, the animation generation logic generates at least a portion of the animation as a function of the re-mapped time value.

In view of the above, certain embodiments of the present invention provide a new model for achieving computer-generated animation effects, such as easing effects. Certain embodiments of this new model do not rely on descriptions of how property values transition between keyframes, but instead it alters the frame time interval for a property. In easing, as described above, the time between frames of the animation is constant and is dictated by the animation's frame rate. Traditional eases describe a percentage transition between keyframe values for each time interval. By altering the amount of time between frames, embodiments of the present invention overcome the limitations of traditional easing and provide many benefits.

Certain embodiments of the present invention provide a time re-mapper that essentially makes the frame intervals of an animation non-linear. That is, the time re-mapper is operable to generate a new re-mapped timeline that is different from the animation's reference timeline, wherein the new re-mapped timeline can be employed to generate tween frames such that the resulting time between frame intervals is non-linear. If an author wants to ease out, i.e. make the animation start faster and end slowly, the author can simply define a time mapping function to be employed by the time re-mapper 404 to increase the frame intervals at the start of the animation and shorten them toward the end. By simply sampling the property value at different times based on the varying frame intervals, a smooth eased animation across all of the properties keyframes can be achieved.

As discussed above, in order to achieve these non-linear frame intervals, a time mapping function, which may be a curve and may be referred to herein as a “time map.” Such a time map is a simple graph of frame time vs. property time. This mapping is used to reinterpret the times of the property graph in order to create easing of the properties value. Animation software typically calculates a frames property values based on a frames time. Again, the frames are always a set duration, or set amount of time apart. When using a time map, the software instead uses the frame time to lookup what time to use when getting the property value from the property. So, instead of calculating a property value at, say, 0.5 seconds, the software looks up the value of the time map for a frame time of 0.5 seconds. The time value it gets, which may be referred to herein as “the property time” or re-mapped time, is then used to lookup the value from the property (e.g., according to some defined tweening or other animation effect function, such as graph 504 discussed above).

When implemented via computer-executable instructions, various elements of embodiments of the present invention are in essence the software code defining the operations of such various elements. The executable instructions or software code may be obtained from a readable medium (e.g., a hard drive media, optical media, EPROM, EEPROM, tape media, cartridge media, flash memory, ROM, memory stick, and/or the like).

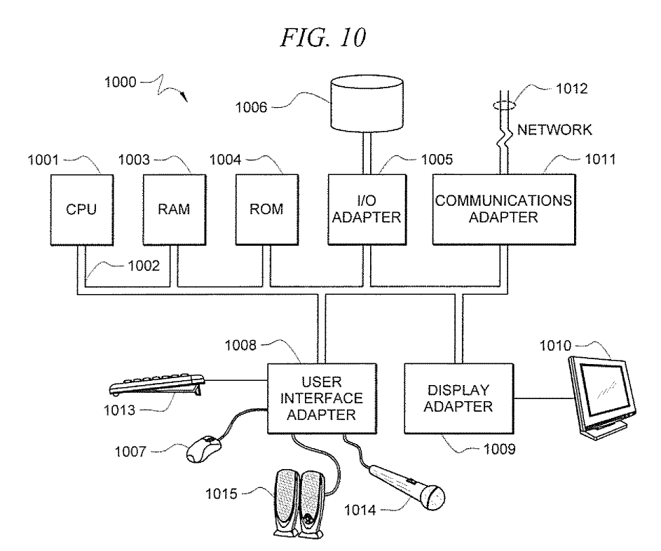

FIG. 10 illustrates an exemplary computer system 1000 on which animation authoring tool 41 may be implemented according to one embodiment of the present invention. Central processing unit (CPU) 1001 is coupled to system bus 1002. CPU 1001 may be any general-purpose CPU. The present invention is not restricted by the architecture of CPU 1001 (or other components of exemplary system 1000) as long as CPU 1001 (and other components of system 1000) supports the inventive operations as described herein. CPU 1001 may execute the various logical instructions according to embodiments of the present invention. For example, CPU 1001 may execute machine-level instructions according to the exemplary operational flow described above in conjunction with FIG. 9.

Computer system 1000 also preferably includes random access memory (RAM) 1003, which may be SRAM, DRAM, SDRAM, or the like. Computer system 1000 preferably includes read-only memory (ROM) 1004 which may be PROM, EPROM, EEPROM, or the like. RAM 1003 and ROM 1004 hold user and system data and programs, as is well known in the art.

Computer system 1000 also preferably includes input/output (I/O) adapter 1005, communications adapter 1011, user interface adapter 1008, and display adapter 1009. I/O adapter 1005, user interface adapter 1008, and/or communications adapter 1011 may, in certain embodiments, enable a user to interact with computer system 1000 in order to input information, such as interacting with a user interface to define a time re-mapping function to be utilized for all or a selected portion of an animation by time re-mapper 404, as described above.

I/O adapter 1005 preferably connects to storage device(s) 1006, such as one or more of hard drive, compact disc (CD) drive, floppy disk drive, tape drive, etc. to computer system 1000. The storage devices may be utilized when RAM 1003 is insufficient for the memory requirements associated with storing data for operations of the authoring tool 41. Communications adapter 1011 is preferably adapted to couple computer system 1000 to network 1012, which may enable information to be input to and/or output from system 1000 via such network 1012 (e.g., the Internet or other wide-area network a local-area network, a public or private switched telephony network, a wireless network, any combination of the foregoing). User interface adapter 1008 couples user input devices, such as keyboard 1013, pointing device 1007, and microphone 1014 and/or output devices, such as speaker(s) 1015 to computer system 1000. Display adapter 1009 is driven by CPU 1001 to control the display on display device 1010 to, for example, display an animation being authored, according to certain embodiments of the present invention.

It shall be appreciated that the present invention is not limited to the architecture of system 1000. For example, any suitable processor-based device may be utilized for implementing authoring tool 41, including without limitation personal computers, laptop computers, computer workstations, and multi-processor servers. Moreover, embodiments of the present invention may be implemented on application specific integrated circuits (ASICs) or very large scale integrated (VLSI) circuits. In fact, persons of ordinary skill in the art may utilize any number of suitable structures capable of executing logical operations according to the embodiments of the present invention.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A method comprising:
receiving, by a processor executing a time re-mapper, a reference timeline for an animation having a plurality of frames, wherein a time interval between frames of the animation is configured to be constant relative to the animation's reference timeline;
generating, by the processor executing the time re-mapper, a re-mapped timeline based on the reference timeline according to a time re-mapping function, wherein the re-mapped timeline comprises non-linear time intervals between a plurality of frames of the animation;
generating, by a processor executing tweening logic, at least one tween frame for the animation, the tweening logic configured to generate the at least one tween frame using linear interpolation based at least in part on the re-mapped timeline, the time re-mapper separate from the tweening logic; and
inserting said at least one tween frame into said animation according to said reference timeline.

2. (canceled)

3. (canceled)

4. (canceled)

5. (canceled)

6. (canceled)

7. (canceled)

8. (canceled)

9. The method of claim 1 wherein the re-mapped timeline results in an easing effect.

10. (canceled)

11. (canceled)

12. The method of claim 1 wherein the re-mapped timeline spans a plurality of keyframe pairs in the animation.

13. The method of claim 1 wherein the reference timeline comprises at least a portion of an animation's reference timeline having constant, linear time intervals, and wherein the re-mapped timeline comprises a new timeline having non-linear time intervals.

14. Computer-executable software code stored to a non-transitory computer-readable medium, which when executed by a computer provides an animation authoring tool with which a user can interact to author animation, and when executed by the computer the software code causes the computer to perform a method comprising:
receiving a reference timeline for an animation having a plurality of frames, wherein a time interval between frames of the animation is configured to be constant relative to the animation's reference timeline;
generating a re-mapped timeline based on the reference timeline according to a time re-mapping function, wherein the re-mapped timeline comprises non-linear time intervals between a plurality of frames of the animation;
generating at least one tween frame for the animation using linear interpolation based at least in part on the re-mapped timeline, and wherein the receiving the reference timeline and generating the re-mapped timeline are by a time re-mapper, and wherein the generating the at least one tween frame is by tweening logic; and
inserting said at least one tween frame into said animation according to said reference timeline.

15. (canceled)

16. The computer-executable software code of claim 14 wherein said generating said at least one tween frame for the animation as a function of the remapped timeline results in an easing effect.

17. The computer-executable software code of claim 14 wherein when executed by the computer the software code causes the computer to further perform:
receiving input specifying the time re-mapping function.

18. The computer-executable software code of claim 14 wherein when executed by the computer the software code causes the computer to further perform:
receiving input specifying a portion of the animation's reference timeline to be re-mapped according to the time re-mapping function.

19. A system comprising:
a computer-readable medium to which instructions are stored;
a processor operable to execute said instructions that when executed by the processor cause the processor to:
execute a re-mapper, the re-mapper configured to:
receive a reference timeline for an animation having a plurality of frames, wherein a time interval between key frames of the animation is constant relative to the animation's reference timeline,
generate a re-mapped timeline based on the reference timeline according to a time re-mapping function, wherein the re-mapped timeline comprises non-linear time intervals between a plurality of key frames of the animation,
execute tweening logic, the tweening logic configured to:
generate at least a portion of the animation using linear interpolation based at least in part on the re-mapped timeline; and
insert said at least one tween frame into said animation according to said reference timeline.

20. (canceled)

21. The system of claim 19 wherein said tweening logic generates at least one tween frame for the animation as a function of the re-mapped timeline.

22. The system of claim 21 wherein generation of the at least one tween frame by the tweening logic as a function of the re-mapped timeline results in an easing effect in the animation.

23. The system of claim 19 wherein the processor is further operable to execute said instructions that when executed by the processor causes the processor to receive user input specifying the time re-mapping function.

24. The method of claim 1, wherein generating the re-mapped timeline is based at least in part on a second re-mapped timeline, wherein the second re-mapped timeline is based on a second time re-mapping function and comprises non-linear time intervals between a plurality of frames of the animation.

25. The computer-executable software code of claim 14 wherein generating the re-mapped timeline is based at least in part on a second re-mapped timeline, wherein the second re-mapped timeline is based on a second time re-mapping function and comprises non-linear time intervals between a plurality of frames of the animation.

26. The system of claim 19, wherein the instructions, that when executed by the processor, generate the re-mapped timeline, generate the re-mapped timeline based at least in part on a second re-mapped timeline, wherein the second re-mapped timeline is based on a second time re-mapping function and comprises non-linear time intervals between a plurality of frames of the animation.

27. The method of claim 1, wherein at least two of the plurality of frames comprises a plurality of properties, and wherein the at least one tween frame is generated using linear interpolation based at least in part on the re-mapped timeline and at least one of the plurality of properties.

28. The method of claim 27, further comprising generating, by the processor executing the time re-mapper, a second re-mapped timeline according to a second time re-mapping function, wherein the second re-mapped timeline comprises non-linear time intervals between a plurality of frames of the animation, and wherein the at least one tween frame is further generated using linear interpolation based at least in part on the re-mapped timeline and the at least one of the plurality of properties and linear interpolation using the second re-mapped timeline and at least one other property than the at least one property.

29. The computer-executable software code of claim 14, wherein at least two of the plurality of frames comprises a plurality of properties, and wherein the at least one tween frame is generated using linear interpolation based at least in part on the re-mapped timeline and at least one of the plurality of properties.

30. The computer-executable software code of claim 29, when executed by the computer the software code causes the computer to perform the method further comprising generating, by the processor executing the time re-mapper, a second re-mapped timeline according to a second time re-mapping function, wherein the second re-mapped timeline comprises non-linear time intervals between a plurality of frames of the animation, and wherein the at least one tween frame is generated using linear interpolation based at least in part on the re-mapped timeline and the at least one of the plurality of properties and linear interpolation using the second re-mapped timeline and at least one other property than the at least one property.

31. The system of claim 19, wherein at least two of the plurality of frames comprises a plurality of properties, and wherein the tween logic is configured to generate at least one tween frame using linear interpolation based at least in part on the re-mapped timeline and at least one property.

32. The system of claim 31, wherein the instructions, that when executed by the processor, further cause the processor to execute the re-mapper to generate a second re-mapped timeline according to a second time re-mapping function, wherein the second re-mapped timeline comprises non-linear time intervals between a plurality of frames of the animation, and wherein the tween logic is further configured to generate the at least one tween frame using linear interpolation using the second re-mapped timeline and at least one other property than the at least one property.

33. The method of claim 1, wherein the re-mapped timeline is generated according to the time re-mapping function and a second time re-mapping function, the second time-remapping function different than the time re-mapping function.

34. The computer-executable software code of claim 14, wherein the re-mapped timeline is generated according to the time re-mapping function and a second time re-mapping function, the second time-remapping function different than the time re-mapping function.

35. The system of claim 19, wherein the re-mapper is configured to generate the re-mapped timeline according to the time re-mapping function and a second time re-mapping function, the second time-remapping function different than the time re-mapping function.

36. The method of claim 1, wherein the re-mapped timeline is based on a first portion of the reference timeline, and further comprising generating a second re-mapped timeline based on a second portion of the reference timeline according to a second time re-mapping function, the first portion of the reference timeline different than the second portion of the remapped timeline.

37. The computer-executable software code of claim 14, wherein the re-mapped timeline is based on a first portion of the reference timeline, and when executed by the computer the software code causes the computer to perform the method further comprising generating a second re-mapped timeline based on a second portion of the reference timeline according to a second time re-mapping function, the first portion of the reference timeline different than the second portion of the remapped timeline.

38. The system of claim 19, wherein the re-mapped timeline is based on a first portion of the reference timeline, and the re-mapper is further configured to generate a second re-mapped timeline based on a second portion of the reference timeline according to a second time re-mapping function, the first portion of the reference timeline different than the second portion of the remapped timeline.
